(19) United States
(12) Patent Application Publication
(10) Pub. No.: US 2008/0101936 A1
(43) Pub. Date: May 1, 2008

(54) Fan for vehicle

(76) Inventors: Jeong-Han Lee, Seongnam-si (KR); Kyung-Wook Nam, Bucheon-si (KR)

Correspondence Address: MORGAN, LEWIS & BOCKIUS LLP (SF), 2 PALO ALTO SQUARE, 3000 El Camino Real, Suite 700, PALO ALTO, CA, 94306, US

(21) Appl. No.: 11/648,888

(22) Filed: Dec. 29, 2006

(30) Foreign Application Priority Data
Nov. 1, 2006 (KR) 10-2006-0107098

(51) Int. Cl. B64C 11/16

(52) U.S. Cl. 416/203

(57) ABSTRACT

A fan for vehicle that considerably reduces noise and vibration by setting the center of gravity of a fan to agree with the rotational center of a fan without any additional means, such as adding a weight or frame thickness, by disposing blades at unequal angular intervals and providing the most suitable arrangement to reduce isolated sound caused by air passing the fan blades.

### CROSS-REFERENCE TO RELATED APPLICATIONS

The present application is based on, and claims priority from, Korean Application Serial Number 10-2006-0107098, filed on Nov. 1, 2006, the disclosure of which is hereby incorporated by reference herein in its entirety.

### FIELD OF THE INVENTION

The present invention relates to a fan for vehicle, and, more particularly, to a reduction of noise and vibration generated while a fan operates.

### BACKGROUND OF THE INVENTION

A plurality of fans may be used for a vehicle, particularly in the related art, fans are mainly used to send air to a radiator or a condenser of an air conditioner that cools down an engine or air-conditions the inside of a vehicle. Such a fan sends air by rotating, creating aerodynamic noise.

The noise can be largely separated into broadband sound over a wide range of frequency and pure tone sound at blade-passing frequencies created when the air passes blades at a same interval. The pure tones are high-frequency, which easily penetrates the cabin in a vehicle.

In FIG. 12, a reference numeral ‘A’ represents isolated sound that causes problems when conventional common fans operate and a blade-passing frequency causing the isolated sound is obtained by product of rotational number of a fan, the number of blades, and an integer.

A method of disposing blades at unequal angular intervals to improve such isolated sound has been disclosed in the related art. However, when blades are irregularly disposed, the center of gravity of a fan is eccentrically positioned with respect to the rotational center and vibration is created. Accordingly, in order to relieve the eccentricity and vibration, it is required to additionally mount a weight to a specific part or thicken a part of a hub with the blades mounted; however, which makes manufacturing of fan difficult and deteriorates assembly characteristics of a hub with a motor. Therefore, it is difficult to obtain compact configuration for a fan.

### SUMMARY OF THE INVENTION

The present invention provides a fan for vehicle that is designed to improve isolated sound of air passing the fan as described above, in which noise and vibration are considerably reduced without any additional means, such as adding a weight or increasing frame thickness, by disposing blades at unequal angular intervals and providing the most suitable arrangement to reduce isolated sound caused by air passing the fan blades.

A fan for vehicle according to an aspect of the present invention having a plurality of blades is provided. As for the above fan, when the blades are represented by vectors with the same magnitude having a starting point at the origin in an X-Y rectangular coordinate system, the sums of X-axis components and Y-axis components of the vectors are both 0.

According to another aspect of the invention, a fan for vehicle is provided in which although blades are disposed at unequal angular intervals, the intervals are determined such that the rotational center of the fan agrees with the center of gravity.

According to another aspect of the invention, a fan having seven blades is provided. The second to seventh blades of them are sequentially disposed in one direction from the first blade. The second blade is disposed at an angle of 44.4±1° from the first blade. The third blade is disposed at an angle of 111.9±1° from the first blade. The fourth blade is disposed at an angle of 147.3±1° from the first blade. The fifth blade is disposed at an angle of 196.7±1° from the first blade. The sixth blade is disposed at an angle of 269.1±1° from the first blade. The seventh blade is disposed at an angle of 298.2±1° from the first blade.

According to another aspect of the invention, a fan having seven blades is provided. The second to seventh blades of them are sequentially disposed in one direction from the first blade. The second blade is disposed at an angle of 42.4±1° from the first blade. The third blade is disposed at an angle of 107.9±1° from the first blade, and the fourth blade is disposed at an angle of 156.3±1° from the first blade. The fifth blade is disposed at an angle of 209.7±1° from the first blade. The sixth blade is disposed at an angle of 244.8±1° from the first blade. The seventh blade is disposed at an angle of 321.1±1° from the first blade.

According to another aspect of the invention, a fan having seven blades is provided. The second to seventh blades of them are sequentially disposed in one direction from the first blade. The second blade is disposed at an angle of 47.4±1° from the first blade. The third blade is disposed at an angle of 100.9±1° from the first blade. The fourth blade is disposed at an angle of 164.3±1° from the first blade. The fifth blade is disposed at an angle of 205.7±1° from the first blade. The sixth blade is disposed at an angle of 246.7±1° from the first blade. The seventh blade is disposed at an angle of 320.4±1° from the first blade.

According to another aspect of the invention, a fan having eight blades is provided. The second to eighth blades of them are sequentially disposed in one direction from the first blade. The second blade is disposed at an angle of 39±1° from the first blade. The third blade is disposed at an angle of 91±1° from the first blade. The fourth blade is disposed at an angle of 145±1° from the first blade. The fifth blade is disposed at an angle of 173±1° from the first blade. The sixth blade is disposed at an angle of 232±1° from the first blade. The seventh blade is disposed at an angle of 260.4±1° from the first blade. The eighth blade is disposed at an angle of 326.6±1° from the first blade.

According to another aspect of the invention, a fan having eight blades is provided. The second to eighth blades of them are sequentially disposed in one direction from the first blade. The second blade is disposed at an angle of 36±1° from the first blade. The third blade is disposed at an angle of 81±1° from the first blade. The fourth blade is disposed at an angle of 130±1° from the first blade. The fifth blade is disposed at an angle of 187±1° from the first blade. The sixth blade is disposed at an angle of 219±1° from the first blade. The seventh blade is disposed at an angle of 251.4±1° from the first blade. The eighth blade is disposed at an angle of 320.0±1° from the first blade.

According to another aspect of the invention, a fan having eight blades is provided. The second to eighth blades of them are sequentially disposed in one direction from a first blade. The second blade is disposed at an angle of 35±1° from the first blade. The third blade is disposed at an angle of 87±1° from the first blade. The fourth blade is disposed at an angle of 143±1° from the first blade. The fifth blade is disposed at an angle of 178±1° from the first blade. The sixth blade is disposed at an angle of 221±1° from the first blade. The seventh blade is disposed at an angle of 261.7±1° from the first blade. The eighth blade is disposed at an angle of 325.7±1° from the first blade.

According to another aspect of the invention, a fan having nine blades is provided. The second to ninth blades of them are sequentially disposed in one direction from the first blade. The second blade is disposed at an angle of 45±1° from the first blade. The third blade is disposed at an angle of 87±1° from the first blade. The fourth blade is disposed at an angle of 115±1° from the first blade. The fifth blade is disposed at an angle of 150±1° from the first blade. The sixth blade is disposed at an angle of 204±1° from the first blade. The seventh blade is disposed at an angle of 250±1° from the first blade. The eighth blade is disposed at an angle of 279±1° from the first blade, and the ninth blade is disposed at 308.9±1° from the first blade.

According to another aspect of the invention, a fan having nine blades is provided. The second to ninth blades of them are sequentially disposed in one direction from the first blade. The second blade is disposed at an angle of 36±1° from the first blade. The third blade is disposed at an angle of 71±1° from the first blade. The fourth blade is disposed at an angle of 130±1° from the first blade. The fifth blade is disposed at an angle of 161±1° from the first blade. The sixth blade is disposed at an angle of 192±1° from the first blade. The seventh blade is disposed at an angle of 243±1° from the first blade. The eighth blade is disposed at an angle of 272.1±1° from the first blade, and the ninth blade is disposed at 328.2±1° from the first blade.

According to another aspect of the invention, a fan having nine blades is provided. The second to ninth blades of them are sequentially disposed in one direction from the first blade. The second blade is disposed at an angle of 31±1° from the first blade. The third blade is disposed at an angle of 81±1° from the first blade. The fourth blade is disposed at an angle of 112±1° from the first blade. The fifth blade is disposed at an angle of 167±1° from the first blade. The sixth blade is disposed at an angle of 199±1° from the first blade. The seventh blade is disposed at an angle of 235±1° from the first blade. The eighth blade is disposed at an angle of 269.7±1° from the first blade, and the ninth blade is disposed at 329.3±1° from the first blade.

### BRIEF DESCRIPTION OF THE DRAWINGS

For a better understanding of the nature and objects of the present invention, reference should be made to the following detailed description with the accompanying drawings, in which:

FIGS. 1 to 9 are views showing a fan for vehicle according to embodiments of the invention;

FIG. 10 is a view showing disposition of blades of a fan using a series of vectors arranged counterclockwise in a rectangular coordinate system;

FIG. 11 is a view comparing effects of the invention with those of an equiangular-typed fan; and

FIG. 12 is a view showing isolated sound generated when a common conventional equiangular-typed fan is operated.

### DETAILED DESCRIPTION OF THE PREFERRED EMBODIMENTS

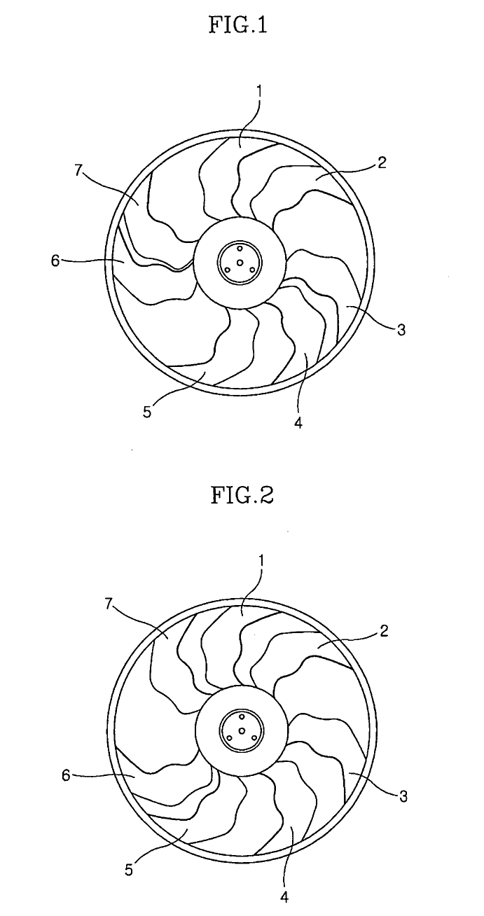

FIG. 1 is a view showing a first embodiment of the invention, in which a fan has seven blades and second to seventh blades 2 to 7 are sequentially disposed clockwise from a first blade 1.

Second blade 2 is disposed at an angle of 44.4±1° from first blade 1, third blade 3 is disposed at an angle of 111.9±1° from first blade 1, fourth blade 4 is disposed at an angle of 147.3±1° from first blade 1, fifth blade 5 is disposed at an angle of 196.7±1° from first blade 1, sixth blade 6 is disposed at an angle of 269.1±1° from first blade 1, and seventh blade 7 is disposed at an angle of 298.2±1° from first blade 1.

When the blades are disposed as described above, the center of gravity of the fan exactly agrees with the rotational axis at the center of the fan, so that while vibration is not generated in rotation, the maximum noise is considerably reduced in operation of the fan as compared with the related art, because isolated sound is reduced by disposing the blades at unequal angular intervals as described above.

The disposition of the blades of the fan in FIG. 1 can be represented by vectors as shown in FIG. 10, that is, by vectors with the same magnitude having the origin as their starting point in an X-Y rectangular coordinate system.

For reference, in FIG. 10, the first blade is represented by an arrow on the X-axis, and the second to seventh blades are represented by arrows disposed counterclockwise.

The following Table 1 shows the X-axis components and Y-axis components of the vectors, and the sum of the components on each axis.

TABLE 1

| Direction | | | | | | | | |
|---|---|---|---|---|---|---|---|---|
| angle | 0 | 44.4 | 111.9 | 147.3 | 196.7 | 269.1 | 298.2 | Sum |
| X-axis | 1.0000 | 0.7145 | −0.3730 | −0.8415 | −0.9578 | −0.0157 | 0.4726 | 0.00 |
| component | | | | | | | | |
| Y-axis | 0.0000 | 0.6997 | 0.9278 | 0.5402 | −0.2874 | −0.9999 | −0.8813 | 0.00 |
| component | | | | | | | | |

As seen from the Table 1, the sums of the X-axis components and the Y-axis components of each vector are 0, respectively.

The above vector analysis is also applicable to all of the embodiments to describe hereafter in the same way, but it will not be described in the embodiments for simple description.

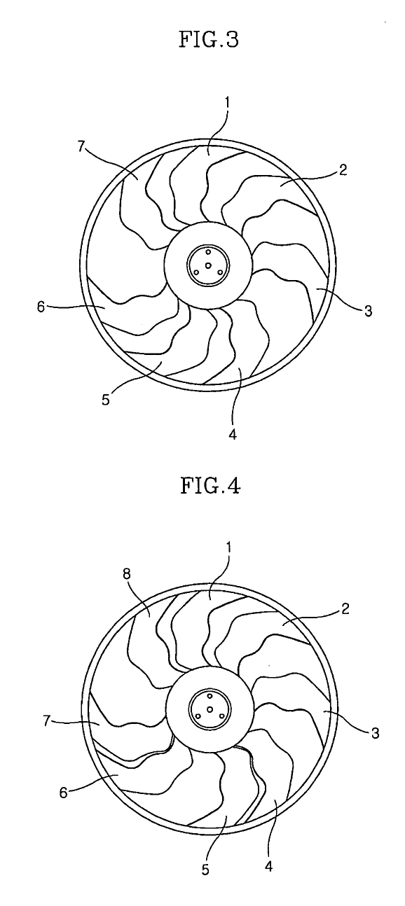

FIG. 2 is a view showing a second embodiment of the invention, in which a fan has seven blades and second to seventh blades 2 to 7 are sequentially disposed clockwise from a first blade 1.

Second blade 2 is disposed at an angle of 42.4±1° from first blade 1, third blade 3 is disposed at an angle of 107.9±1° from first blade 1, fourth blade 4 is disposed at an angle of 156.3±1° from first blade 1, fifth blade 5 is disposed at an angle of 209.7±1° from first blade 1, sixth blade 6 is disposed at an angle of 244.8±1° from first blade 1, and seventh blade 7 is disposed at an angle of 321.1±1° from first blade 1.

As described above in reference to the first embodiment, when the blades are disposed as described above, the center of gravity of the fan exactly agrees with the rotational axis at the center of the fan, so that while vibration is not generated in rotation, the maximum noise is considerably reduced in operation of the fan as compared with the related art, because isolated sound is reduced by disposing the blades at unequal angular intervals as described above.

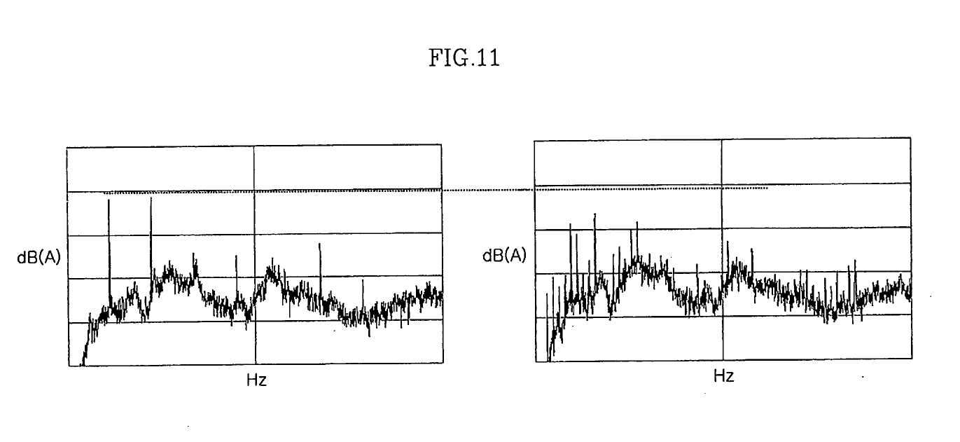

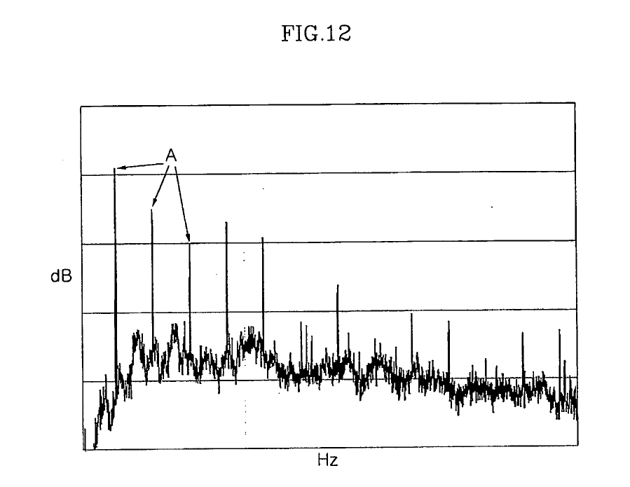

FIG. 11 shows an example for the above reduction of noise. The left one is a graph showing noise levels for each frequency when a conventional equiangular-typed fan is operated, and the right one is a graph constructed when an unequiangular-typed fan according to an embodiment of the invention is operated, where it can be seen that the maximum noise is reduced by about 5 dB compared with the related art.

FIG. 3 is a view showing a third embodiment of the invention, in which a fan has seven blades and second to seventh blades 2 to 7 are sequentially disposed clockwise from a first blade 1.

Second blade 2 is disposed at an angle of 47.4±1° from first blade 1, third blade 3 is disposed at an angle of 100.9±1° from first blade 1, fourth blade 4 is disposed at an angle of 164.3±1° from first blade 1, fifth blade 5 is disposed at an angle of 205.7±1° from first blade 1, sixth blade 6 is disposed at an angle of 246.7±1° from first blade 1, and seventh blade 7 is disposed at an angle of 320.4±1° from first blade 1.

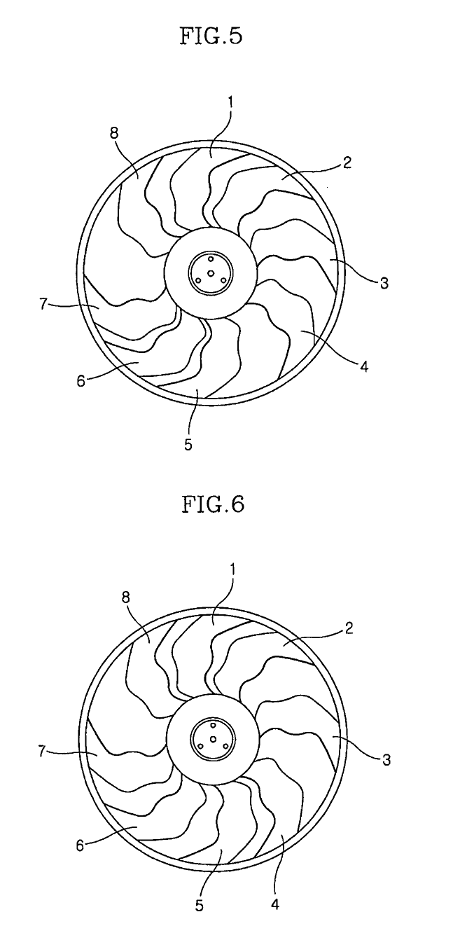

FIG. 4 is a view showing a fourth embodiment of the invention, in which a fan has eight blades and second to eighth blades 2 to 8 are sequentially disposed clockwise from a first blade 1.

Second blade 2 is disposed at an angle of 39±1° from first blade 1, third blade 3 is disposed at an angle of 91±1° from first blade 1, fourth blade 4 is disposed at an angle of 145±1° from first blade 1, fifth blade 5 is disposed at an angle of 173±1° from first blade 1, sixth blade 6 is disposed at an angle of 232±1° from first blade 1, seventh blade 7 is disposed at an angle of 260.4±1° from first blade 1, and eighth blade 8 is disposed at an angle of 326.6±1° from first blade 1.

FIG. 5 is a view showing a fifth embodiment of the invention, in which a fan has eight blades and second to eighth blades 2 to 8 are sequentially disposed clockwise from a first blade 1.

Second blade 2 is disposed at an angle of 36±1° from first blade 1, third blade 3 is disposed at an angle of 81±1° from first blade 1, fourth blade 4 is disposed at an angle of 130±1° from first blade 1, fifth blade 5 is disposed at an angle of 187±1° from first blade 1, sixth blade 6 is disposed at an angle of 219±1° from first blade 1, seventh blade 7 is disposed at an angle of 251.4±1° from first blade 1, and eighth blade 8 is disposed at an angle of 320.0±1° from first blade 1.

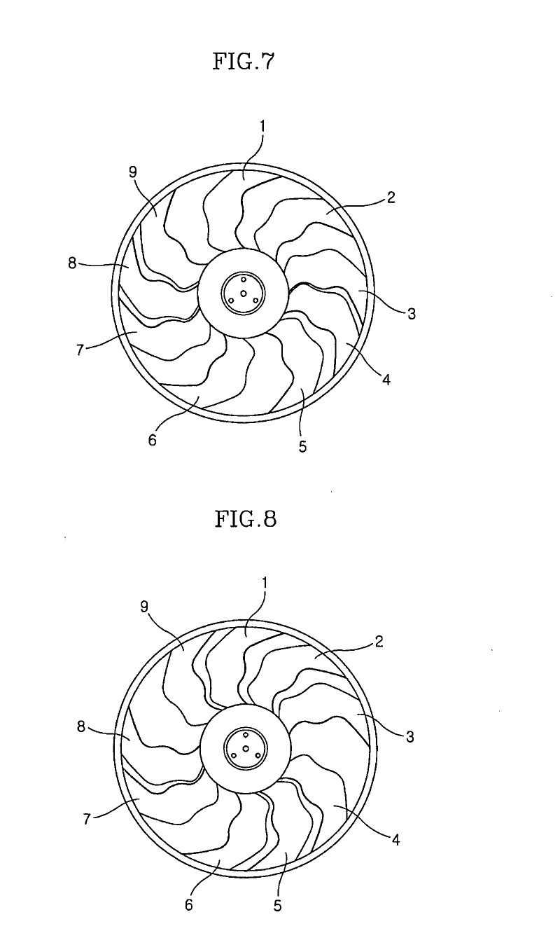

FIG. 6 is a view showing a sixth embodiment of the invention, in which a fan has eight blades and a second blade 2 to an eighth blade 8 are sequentially disposed clockwise from a first blade 1.

Second blade 2 is disposed at an angle of 35±1° from first blade 1, third blade 3 is disposed at an angle of 87±1° from first blade 1, fourth blade 4 is disposed at an angle of 143±1° from first blade 1, fifth blade 5 is disposed at an angle of 178±1° from first blade 1, sixth blade 6 is disposed at an angle of 221±1° from first blade 1, seventh blade 7 is disposed at an angle of 261.7±1° from first blade 1, and eighth blade 8 is disposed at an angle of 325.7±1° from first blade 1.

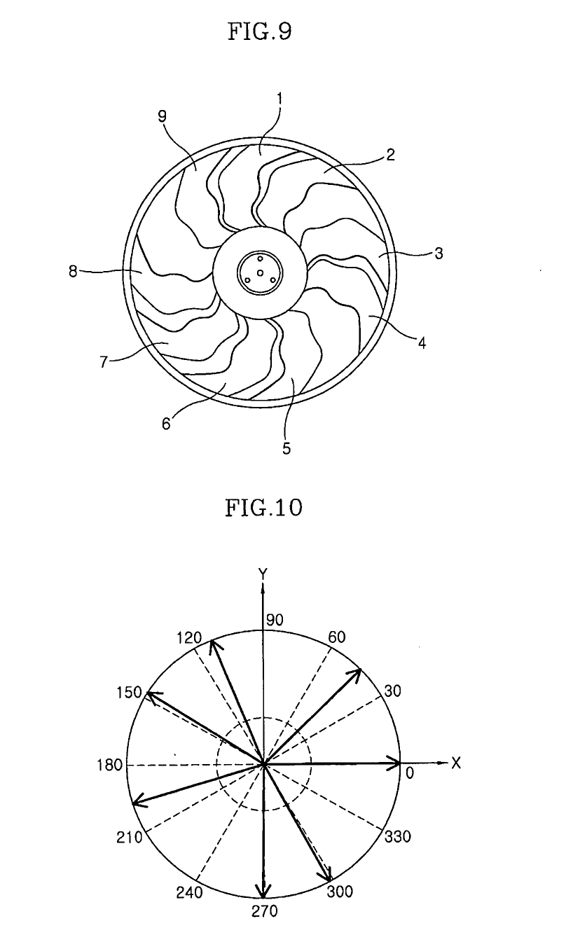

FIG. 7 is a view showing a seventh embodiment of the invention, in which a fan has nine blades and second to ninth blades 2 to 9 are sequentially disposed clockwise from a first blade 1.

Second blade 2 is disposed at an angle of 45±1° from first blade 1, third blade 3 is disposed at an angle of 87±1° from first blade 1, fourth blade 4 is disposed at an angle of 115±1° from first blade 1, fifth blade 5 is disposed at an angle of 150±1° from first blade 1, sixth blade 6 is disposed at an angle of 204±1° from first blade 1, seventh blade 7 is disposed at an angle of 250±1° from first blade 1, eighth blade 8 is disposed at an angle of 279±1° from first blade 1, and ninth blade 9 is disposed at 308.9±1° from first blade 1.

FIG. 8 is a view showing an eighth embodiment of the invention, in which a fan has nine blades and second to ninth blades 2 to 9 are sequentially disposed clockwise from a first blade 1.

Second blade 2 is disposed at an angle of 36±1° from first blade 1, third blade 3 is disposed at an angle of 71±1° from first blade 1, fourth blade 4 is disposed at an angle of 130±1° from first blade 1, fifth blade 5 is disposed at an angle of 161±1° from first blade 1, sixth blade 6 is disposed at an angle of 192±1° from first blade 1, seventh blade 7 is disposed at an angle of 243±1° from first blade 1, eighth blade 8 is disposed at an angle of 272.1±1° from first blade 1, and ninth blade 9 is disposed at an angle of 328.2±1° from first blade 1.

FIG. 9 is a view showing a ninth embodiment of the invention, in which a fan has nine blades and second to ninth blades 2 to 9 are sequentially disposed clockwise from a first blade 1.

Second blade 2 is disposed at an angle of 31±1° from first blade 1, third blade 3 is disposed at an angle of 81±1° from first blade 1, fourth blade 4 is disposed at an angle of 112±1° from first blade 1, fifth blade 5 is disposed at an angle of 167±1° from first blade 1, sixth blade 6 is disposed at an angle of 199±1° from first blade 1, seventh blade 7 is disposed at an angle of 235±1° from first blade 1, eighth blade 8 is disposed at an angle of 269.7±1° from first blade 1, and ninth blade 9 is disposed at 329.3±1° from first blade 1.

Similar to the first and second embodiments, in the third to ninth embodiments, although the blades composing each fan are disposed at unequal angular intervals, the rotational center of each fan agrees with the center of gravity, so that while isolated sound are reduced in operation of the fan and vibration is not generated in the fan; therefore it can steadily rotate.

As described above, since the individual disposition angles for the blades are determined such that the center of gravities and the rotational centers agree with each other, it is possible to overcome problems in the related art in that it is difficult to connect a fan with a motor to drive the fan by mounting a weight to a hub or increasing frame thickness and to manufacture the fan itself.

As described above, according to the embodiments of the invention, noise and vibration are considerably reduced by setting the center of gravity of a fan to agree with the rotational center of a fan without any additional means, such as adding a weight or frame thickness, by disposing blades at unequal angular intervals and providing the most suitable arrangement to reduce isolated sound caused by air passing the fan blades.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A fan for vehicle, comprising a plurality of blades, arranged around a center of gravity, wherein when the blades are represented by vectors with a common magnitude having a starting point at an origin in an X-Y rectangular coordinated system, wherein sums of X-axis components and Y-axis components of the vectors are both 0.

2. The fan as defined in claim 1, wherein the blades are disposed at unequal angular intervals, and the angular intervals are determined such that a rotational center of the fan corresponds with the center of gravity.

3. The fan as defined in claim 2, wherein:
the fan includes seven blades;
the second to seventh blades are sequentially disposed in one direction from the first blade;
the second blade is disposed at an angle of 44.4±1° from the first blade;
the third blade is disposed at an angle of 111.9±1° from the first blade;
the fourth blade is disposed at an angle of 147.3±1° from the first blade;
the fifth blade is disposed at an angle of 196.7±1° from the first blade;
the sixth blade is disposed at an angle of 269.1±1° from the first blade; and
the seventh blade is disposed at an angle of 298.2±1° from the first blade.

4. The fan as defined in claim 2, wherein:
the fan includes seven blades;
the second to seventh blades are sequentially disposed in one direction from the first blade;
the second blade is disposed at an angle of 42.4±1° from the first blade;
the third blade is disposed at an angle of 107.9±1° from the first blade;
the fourth blade is disposed at an angle of 156.3±1° from the first blade;
the fifth blade is disposed at an angle of 209.7±1° from the first blade;
the sixth blade is disposed at an angle of 244.8±1° from the first blade; and
the seventh blade is disposed at an angle of 321.1±1° from the first blade.

5. The fan as defined in claim 2, wherein:
the fan includes seven blades;
the second to seventh blades are sequentially disposed in one direction from the first blade;
the second blade is disposed at an angle of 47.4±1° from the first blade;
the third blade is disposed at an angle of 100.9±1° from the first blade;
the fourth blade is disposed at an angle of 164.3±1° from the first blade;
the fifth blade is disposed at an angle of 205.7±1° from the first blade;
the sixth blade is disposed at an angle of 246.7±1° from the first blade; and
the seventh blade is disposed at an angle of 320.4±1° from the first blade.

6. The fan as defined in claim 2, wherein:
the fan includes eight blades;
the second to eighth blades are sequentially disposed in one direction from the first blade;
the second blade is disposed at an angle of 39±1° from the first blade;
the third blade is disposed at an angle of 91±1° from the first blade;
the fourth blade is disposed at an angle of 145±1° from the first blade;
the fifth blade is disposed at an angle of 173±1° from the first blade;
the sixth blade is disposed at an angle of 232±1° from the first blade;
the seventh blade is disposed at an angle of 260.4±1° from the first blade; and
the eighth blade is disposed at an angle of 326.6±1° from the first blade.

7. The fan as defined in claim 2, wherein:
the fan includes eight blades;
the second to eighth blades are sequentially disposed in one direction from the first blade;
the second blade is disposed at an angle of 36±1° from the first blade;
the third blade is disposed at an angle of 81±1° from the first blade;
the fourth blade is disposed at an angle of 130±1° from the first blade;
the fifth blade is disposed at an angle of 187±1° from the first blade;
the sixth blade is disposed at an angle of 219±1° from the first blade;
the seventh blade is disposed at an angle of 251.4±1° from the first blade; and
the eighth blade is disposed at an angle of 320.0±1° from the first blade.

8. The fan as defined in claim 2, wherein:
the fan includes eight blades;
the second to eighth blades are sequentially disposed in one direction from the first blade;
the second blade is disposed at an angle of 35±1° from the first blade;
the third blade is disposed at an angle of 87±1° from the first blade;
the fourth blade is disposed at an angle of 143±1° from the first blade;
the fifth blade is disposed at an angle of 178±1° from the first blade;
the sixth blade is disposed at an angle of 221±1° from the first blade;
the seventh blade is disposed at an angle of 261.7±1° from the first blade; and
the eighth blade is disposed at an angle of 325.7±1° from the first blade.

9. The fan as defined in claim 2, wherein:
the fan includes nine blades;
the second to ninth blades are sequentially disposed in one direction from the first blade;
the second blade is disposed at an angle of 45±1° from the first blade;
the third blade is disposed at an angle of 87±1° from the first blade;
the fourth blade is disposed at an angle of 115±1° from the first blade;
the fifth blade is disposed at an angle of 150±1° from the first blade;
the sixth blade is disposed at an angle of 204±1° from the first blade;
the seventh blade is disposed at an angle of 250±1° from the first blade;
the eighth blade is disposed at an angle of 279±1° from the first blade; and
the ninth blade is disposed at an angle of 308.9±1° from the first blade.

10. The fan as defined in claim 2, wherein:
the fan includes nine blades;
the second to ninth blades are sequentially disposed in one direction from the first blade;
the second blade is disposed at an angle of 36±1° from the first blade;
the third blade is disposed at an angle of 71±1° from the first blade;
the fourth blade is disposed at an angle of 130±1° from the first blade;
the fifth blade is disposed at an angle of 161±1° from the first blade;
the sixth blade is disposed at an angle of 192±1° from the first blade;
the seventh blade is disposed at an angle of 243±1° from the first blade;
the eighth blade is disposed at an angle of 272.1±1° from the first blade; and
the ninth blade is disposed at an angle of 328.2±1° from the first blade.

11. The fan as defined in claim 2, wherein:
the fan includes nine blades;
the second to ninth blades are sequentially disposed in one direction from the first blade;
the second blade is disposed at an angle of 31±1° from the first blade;
the third blade is disposed at an angle of 81±1° from the first blade;
the fourth blade is disposed at an angle of 112±1° from the first blade;
the fifth blade is disposed at an angle of 167±1° from the first blade;
the sixth blade is disposed at an angle of 199±1° from the first blade;
the seventh blade is disposed at an angle of 235±1° from the first blade;
the eighth blade is disposed at an angle of 269.7±1° from the first blade; and
the ninth blade is disposed at an angle of 329.3±1° from the first blade.
